(19) United States
(12) Patent Application Publication
(10) Pub. No.: US 2024/0120142 A1
(43) Pub. Date: Apr. 11, 2024

(54) ELECTRONIC COMPONENT

(71) Applicant: TDK CORPORATION, Tokyo (JP)

(72) Inventors: Yoji TOZAWA, Tokyo (JP); Masashi SHIMOYASU, Tokyo (JP); Akihiko OIDE, Tokyo (JP); Daiki KATO, Tokyo (JP); Makoto YOSHINO, Tokyo (JP); Takashi ENDO, Tokyo (JP); Takuya KODAMA, Tokyo (JP); Akira AKASAKA, Tokyo (JP); Ken ITOH, Tokyo (JP)

(73) Assignee: TDK CORPORATION, Tokyo (JP)

(21) Appl. No.: 18/480,760

(22) Filed: Oct. 4, 2023

(30) Foreign Application Priority Data
Oct. 5, 2022 (JP) 2022-160895

(51) Int. Cl. H01F 27/02; H01F 27/29

(52) U.S. Cl. CPC H01F 27/022; H01F 27/29

(57) ABSTRACT

The electronic component includes an element body, an internal conductor, a cover layer, and a conductor layer. The internal conductor is disposed in the element body. The cover layer is disposed on an outer surface of the element body and has an electrical insulation property. The conductor layer is disposed on the cover layer and is electrically connected to the internal conductor. The conductor layer includes a portion. The portion protrudes toward the element body through the cover layer and is physically and electrically connected to the internal conductor. The conductor layer is electrically connected to the internal conductor.

### CROSS-REFERENCE TO RELATED APPLICATIONS

This application is based upon and claims the benefit of priority from Japanese Patent Application No. 2022-160895, filed on Oct. 5, 2022. The entire contents of which are incorporated herein by reference.

### BACKGROUND

### Field

The present disclosure relates to an electronic component.

### Description of the Related Art

Known electronic components include an element body, an internal conductor, and a conductor layer (for example, refer to Japanese Unexamined Patent Publication No. 2014-27071). The internal conductor is disposed in the element body. The conductor layer is disposed on the element body and is electrically connected to the internal conductor.

### SUMMARY

The electronic component including a cover layer on an outer surface of the element body tends to increase mechanical strength of the element body. The conductor layer is disposed on the cover layer. The cover layer usually has an electrical insulation property. Therefore, the electronic component including the cover layer may lower physical and electrical connectivity between the internal conductor and the conductor layer.

An object of an aspect of the present disclosure is to provide an electronic component that prevents a decrease in physical and electrical connectivity between an internal conductor and a conductor layer.

An electronic component according to one aspect of the present disclosure includes an element body, an internal conductor, a cover layer, and a conductor layer. The internal conductor is disposed in the element body. The cover layer is disposed on an outer surface of the element body and has an electrical insulation property. The conductor layer is disposed on the cover layer and is electrically connected to the internal conductor. The conductor layer includes a portion. The portion of the conductor layer protrudes toward the element body through the cover layer and is physically and electrically connected to the internal conductor.

In the one aspect, the conductor layer includes the portion. Therefore, the one aspect prevents a decrease in physical and electrical connectivity between the internal conductor and the conductor layer.

In the one aspect, the outer surface may include an end surface at which the internal conductor is exposed, and the cover layer may be disposed on the end surface.

In the one aspect, the internal conductor may include an end exposed at the end surface. The portion of the conductor layer may cover the end of the internal conductor when the end and the portion are viewed in a direction orthogonal to the end surface.

The configuration in which the portion of the conductor layer covers the end of the internal conductor reliably physically and electrically connects the internal conductor and the conductor layer.

In the one aspect, an opening may be formed in the cover layer at a position corresponding to the portion of the conductor layer. An edge included in the cover layer and defining the opening may be positioned on the end surface when viewed in the direction orthogonal to the end surface.

The configuration in which the edge of the cover layer is positioned on the end surface when viewed in the direction orthogonal to the end surface reliably positions the portion on the end surface. Therefore, the configuration reliably prevents a decrease in physical and electrical connectivity between the conductor layer and the internal conductor.

In the one aspect, an opening may be formed in the cover layer at a position corresponding to the portion in the cover layer. The end surface may include a first region exposed from the cover layer through the opening, and a second region covered with the cover layer. The first region may be recessed relative to the second region.

The configuration in which the first region is recessed relative to the second region increases a connection area between the element body and the conductor layer. Therefore, the configuration strengthens physical connectivity between the conductor layer and the element body. As a result, the configuration more reliably prevents a decrease in physical and electrical connectivity between the internal conductor and the conductor layer.

In the one aspect, an opening may be formed in the cover layer at a position corresponding to the portion. The end surface may include a first region exposed from the cover layer through the opening, and a second region covered with the cover layer. Surface roughness of the first region may be larger than surface roughness of the second region.

The configuration in which the surface roughness of the first region is larger than the surface roughness of the second region increases a surface area of the element body in the first region and increases the connection area between the element body and the conductor layer. Therefore, the configuration strengthens physical connectivity between the conductor layer and the element body. As a result, the configuration more reliably prevents a decrease in physical and electrical connectivity between the internal conductor and the conductor layer.

In the one aspect, the outer surface may include a side surface adjacent to the end surface, and the cover layer may be disposed continuously on the end surface and the side surface.

The configuration in which the cover layer is continuously disposed on the end surface and the side surface reliably improves mechanical strength of the element body.

In the one aspect, the cover layer may have a thickness of 1 to 3 μm.

The configuration in which the cover layer has the above thickness further improves mechanical strength of the element body.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view illustrating an electronic component according to an example;

FIG. 2 is a view illustrating a cross-sectional configuration of the electronic component according to the present example;

FIG. 3 is an exploded perspective view of a coil;

FIG. 4 is a view illustrating a cross-sectional configuration of the electronic component according to the present example;

FIG. 5 is a view illustrating a cross-sectional configuration of the electronic component according to the present example;

FIG. 6 is a view illustrating a cross-sectional configuration of an end surface; and

FIG. 7 is a view illustrating a cross-sectional configuration of an electronic component according to a modification of the present example.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

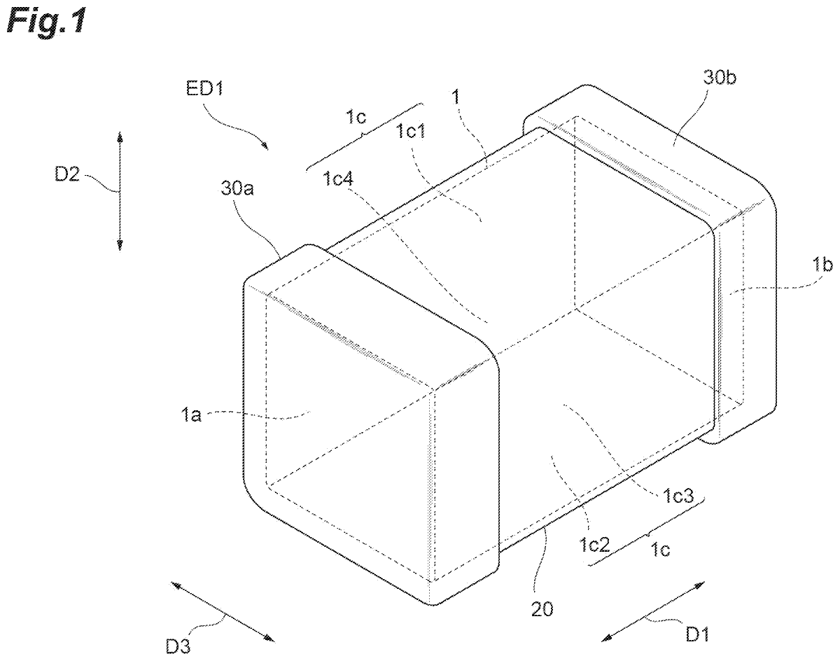

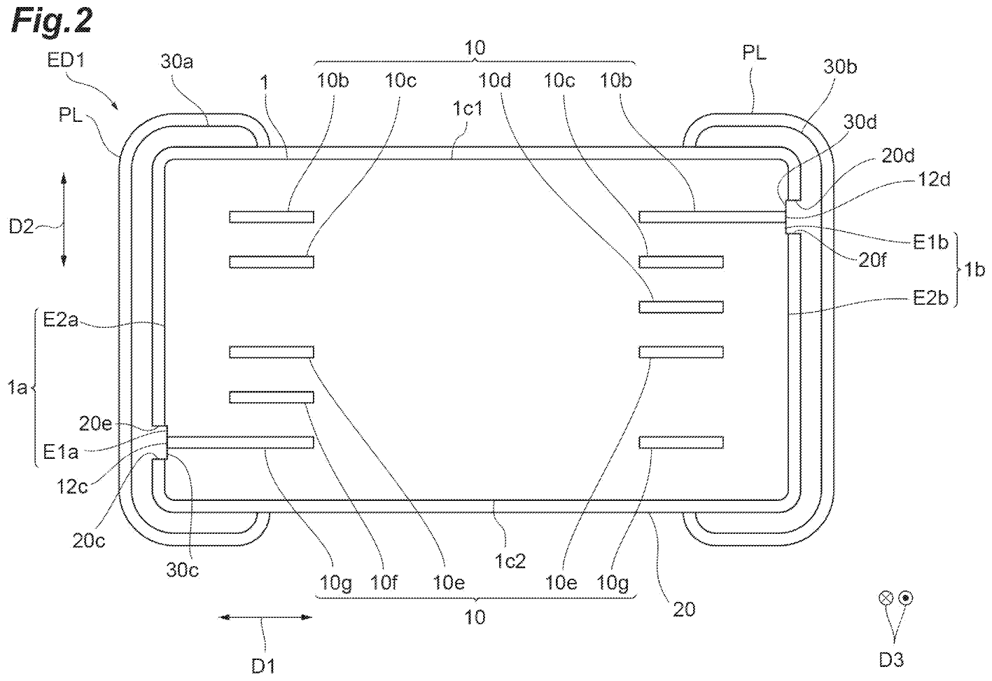

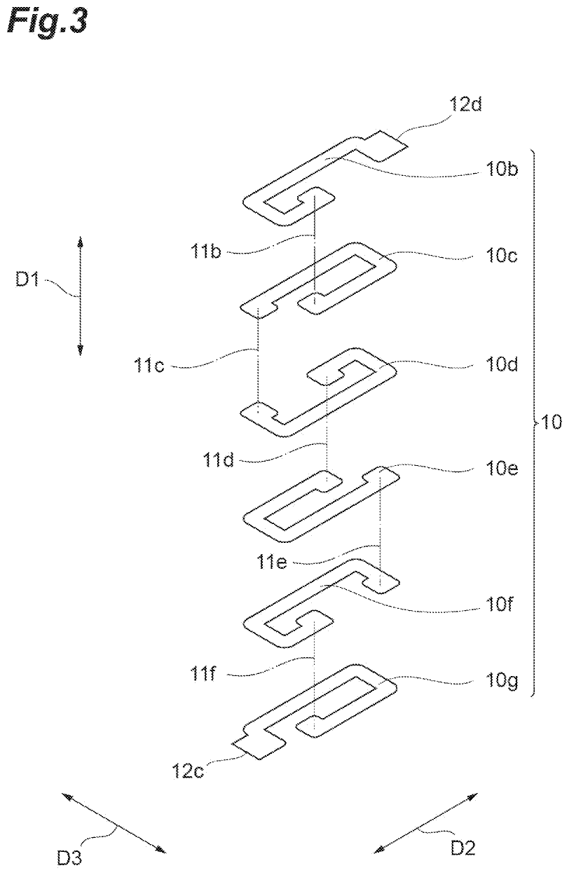

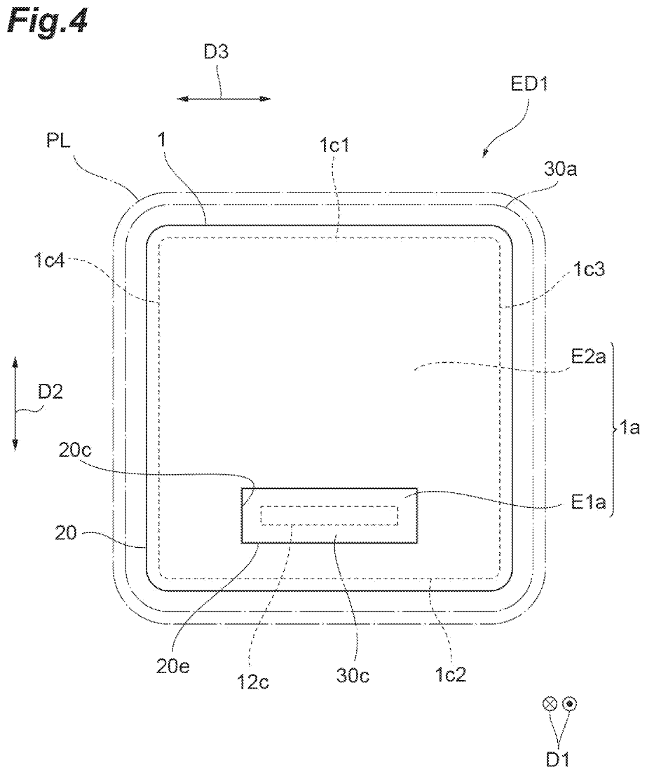

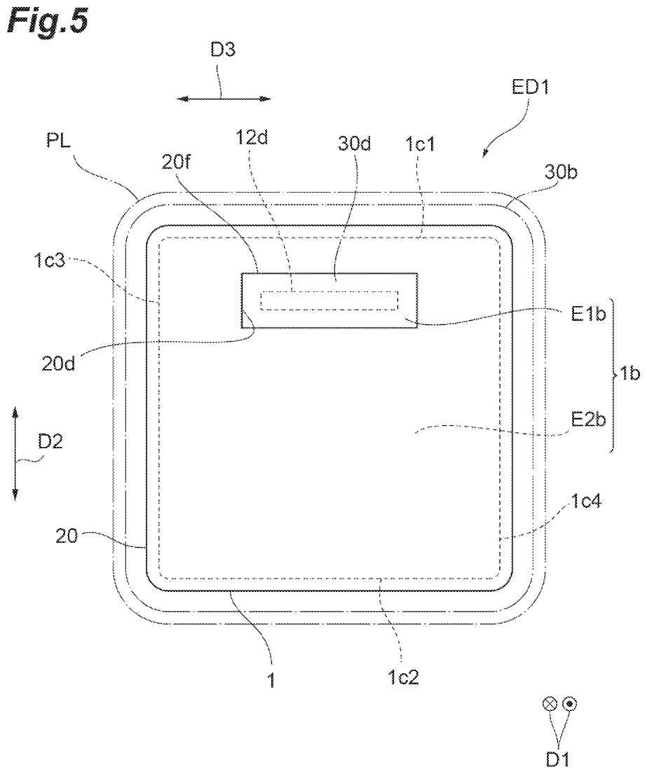

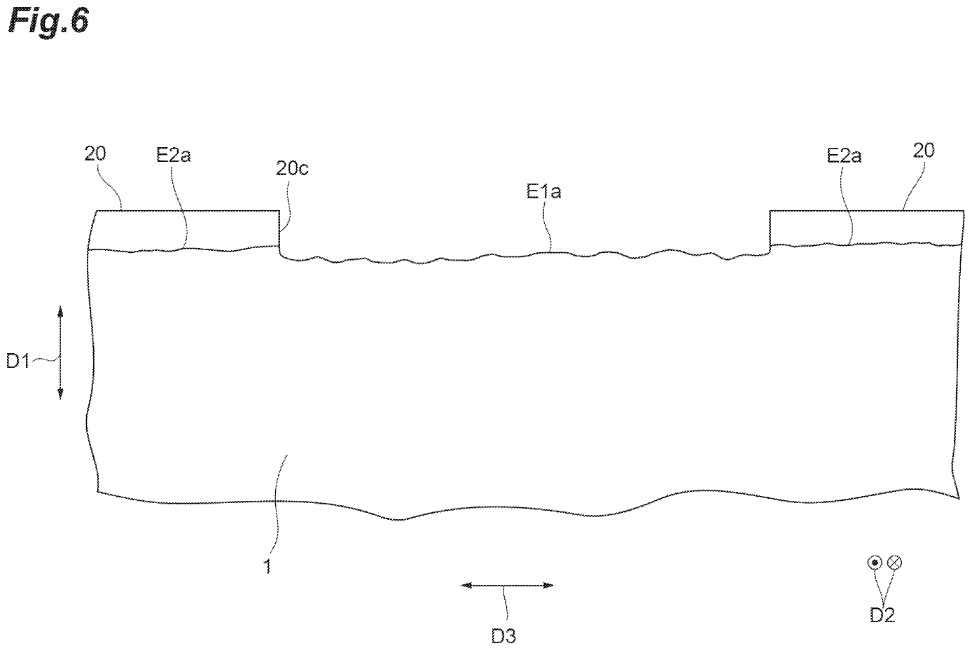

An electronic component ED1 according to the present example will be described with reference to FIGS. 1 to 6. FIG. 1 is a perspective view illustrating the electronic component according to the present example. FIG. 2 is a view illustrating a cross-sectional configuration of the electronic component according to the present example; FIG. 3 is an exploded perspective view of a coil; FIG. 4 and FIG. 5 are views illustrating a cross-sectional configuration of the electronic component according to the present example. FIG. 6 is a view illustrating a cross-sectional configuration of an end surface. The electronic component ED1 includes, for example, a multilayer coil component.

As illustrated in FIGS. 1 and 2, the electronic component ED1 includes an element body 1, a coil 10, a cover layer 20, and conductor layers 30a and 30b. The coil 10 and the conductor layers 30a and 30b have electrically conductive properties. The coil 10 is disposed in the element body 1. The cover layer 20 is disposed on an outer surface of the element body 1. The conductor layers 30a and 30b are disposed on the cover layer 20 and are electrically connected to the coil 10. In FIG. 2, hatching is omitted to clearly illustrate each element.

The element body 1 has, for example, a rectangular parallelepiped shape. The outer surface of the element body 1 includes a pair of end surfaces 1a and 1b opposing each other and a side surface 1c coupling the end surfaces 1a and 1b. The side surface 1c is adjacent to the end surfaces 1a and 1b. The side surface 1c includes a pair of side surfaces 1c1 and 1c2 opposing each other and a pair of side surfaces 1c3 and 1c4 opposing each other. The end surfaces 1a and 1b, the side surfaces 1c1 and 1c2, and the side surfaces 1c3 and 1c4 have, for example, a rectangular shape. A “rectangular parallelepiped shape” in the present specification includes a rectangular parallelepiped shape in which corner portions and ridge portions are chamfered, or a rectangular parallelepiped shape in which corner portions and ridge portions are rounded. A “rectangular shape” in the present specification includes, for example, a shape in which each corner is chamfered or a shape in which each corner is rounded.

The end surfaces 1a and 1b oppose each other in a first direction D1. The end surfaces 1a and 1b define both ends of the element body 1 in the first direction D1. The end surfaces 1a and 1b are, for example, orthogonal to the first direction D1. The side surfaces 1c1 and 1c2 are adjacent to the end surfaces 1a and 1b and oppose each other in a second direction D2. The second direction D2 intersects the first direction D1. The side surfaces 1c1 and 1c2 define both ends of the element body 1 in the second direction D2. The side surfaces 1c1 and 1c2 are, for example, orthogonal to the second direction D2. The side surfaces 1c3 and 1c4 are adjacent to the end surfaces 1a and 1b and the side surfaces 1c1 and 1c2, and oppose each other in a third direction D3. The third direction D3 intersects the first direction D1 and the second direction D2. The side surfaces 1c3 and 1c4 define both ends of the element body 1 in the third direction D3. The side surfaces 1c3 and 1c4 are, for example, orthogonal to the third direction D3. In the present example, the first direction D1, the second direction D2, and the third direction D3 are orthogonal to each other.

The end surfaces 1a and 1b extend in the second direction D2 to couple the side surface 1c1 and the side surface 1c2. The end surfaces 1a and 1b extend in the third direction D3 to couple the side surface 1c3 and the side surface 1c4. The side surfaces 1c1 and 1c2 extend in the first direction D1 to couple the end surface 1a and the end surface 1b. The side surfaces 1c1 and 1c2 extend in the third direction D3 to couple the side surface 1c3 and the side surface 1c4. The side surfaces 1c3 and 1c4 extend in the first direction D1 to couple the end surface 1a and the end surface 1b. The side surfaces 1c3 and 1c4 extend in the second direction D2 to couple the side surface 1c1 and the side surface 1c2. The end surfaces 1a and 1b, the side surfaces 1c1 and 1c2, and the side surfaces 1c3 and 1c4 may be indirectly adjacent to each other. In this case, a ridge portion is positioned between the end surfaces 1a and 1b, the side surfaces 1c1 and 1c2, and the side surfaces 1c3 and 1c4.

A length of the element body 1 in the first direction D1 is, for example, 1.6 mm A length of the element body 1 in the second direction D2 is, for example, 0.8 mm A length of the element body 1 in the third direction D3 is, for example, 0.8 mm. In the element body 1, for example, the first direction D1 is a long side direction.

The element body 1 includes, for example, a plurality of insulator layers. The element body 1 is formed through laminating the plurality of insulator layers, for example. In the present example, a direction in which the plurality of insulator layers are laminated is the second direction D2. The plurality of insulator layers are integrated to such an extent that boundaries between the insulator layers cannot be visually recognized. Each insulator layer includes, for example, a magnetic material. The magnetic material includes, for example, a Ni—Cu—Zn-based ferrite material, a Ni—Cu—Zn—Mg-based ferrite material, a Cu—Zn-based ferrite material, or a Ni—Cu-based ferrite material. The magnetic material may include, for example, a Fe alloy. Each insulator layer may include a non-magnetic material. The non-magnetic material includes, for example, a glass ceramic material or a dielectric material. The glass ceramic material includes, for example, glass and alumina. The glass included in the glass ceramic material includes, for example, strontium, calcium, alumina, or silicon oxide. Each insulator layer is formed of, for example, a sintered body of a green sheet including the above-described material.

As illustrated in FIGS. 2 and 3, the coil 10 includes a plurality of coil conductors 10b, 10c, 10d, 10e, 10f, and 10g. The coil 10 includes a plurality of through-hole conductors 11b to 11f. Through-hole conductors 11b to 11f have electrically conductive properties. The coil conductors 10b and 10c adjacent to each other are electrically connected by the through-hole conductor 11b. The coil conductors 10c and 10d adjacent to each other are electrically connected by the through-hole conductor 11c. The coil conductors 10d and 10e adjacent to each other are electrically connected by the through-hole conductor 11d. The coil conductors 10e and 10f adjacent to each other are electrically connected by the through-hole conductor 11e. The coil conductors 10f and 10g adjacent to each other are electrically connected by the through-hole conductor 11f.

The plurality of coil conductors 10b to 10g are electrically connected to each other and disposed in the element body 1. In the present example, an axial direction of the coil 10 is the second direction D2. The coil conductors adjacent to each other, among the coil conductors 10b to 10g, are disposed to at least partially overlap each other when viewed in the first direction D1. The coil 10 has, for example, a spiral shape. For example, the coil conductors 10b to 10g are disposed in the order of the coil conductor 10b, the coil conductor 10c, the coil conductor 10d, the coil conductor 10e, the coil conductor 10f, and the coil conductor 10g. The coil conductor 10b is adjacent to the side surface 1c1, for example. The coil conductor 10g is adjacent to the side surface 1c2, for example.

The plurality of coil conductors 10b, 10c, 10d, 10e, 10f, and 10g are included in, for example, an internal conductor.

The coil conductor 10b includes an end 12d exposed at the end surface 1b. The coil conductor 10b is exposed at the end surface 1b through the end 12d. The coil conductor 10b is physically and electrically connected to the conductor layer 30b through the end 12d. One end of the coil 10 is physically and electrically connected to the conductor layer 30b.

The coil conductor 10g includes an end 12c exposed at the end surface 1a. The coil conductor 10g is exposed at the end surface 1a through the end 12c. The coil conductor 10g is physically and electrically connected to the conductor layer 30a through the end 12c. The other end of the coil 10 is physically and electrically connected to the conductor layer 30a.

The coil 10 is electrically connected to the conductor layer 30a and the conductor layer 30b.

The plurality of coil conductors 10b to 10g are configured as, for example, a sintered body of a conductive paste including a conductive material. The through-hole conductors 11b to 11f are included as, for example, a conductive material, and are configured as a sintered body of a conductive paste including a conductive material. The conductive material included in the coil conductors 10b to 10g and the through-hole conductors 11b to 11f includes, for example, Ag, Pd, Au, Pt, Cu, Ni, Al, Mo, or W. The conductive material may include an Ag—Pd alloy, an Ag—Cu alloy, an Ag—Au alloy, or an Ag—Pt alloy.

As illustrated in FIGS. 1 and 2, the cover layer 20 is disposed on the outer surface of the element body 1. The cover layer 20 has an electrical insulation property. In the present example, the cover layer 20 is disposed on the entire outer surface of the element body 1. The cover layer 20 is disposed on the end surfaces 1a and 1b. The cover layer 20 is continuously disposed on the end surfaces 1a and 1b and the side surface 1c. The cover layer 20 is disposed on the entire side surface 1c. The cover layer 20 may be disposed on a part of the side surface 1c. The cover layer includes a cover portion positioned on the end surface 1a, a cover portion positioned on the end surface 1b, and a cover portion positioned on the side surface 1c. The cover portion positioned on the side surface 1c is continuous with the cover portion positioned on the end surface 1a and is continuous with the cover portion positioned on the end surface 1b. The cover portions included in the cover layer 20 may be integrally formed with each other. For example, when the cover portion positioned on the end surface 1a includes a first cover portion, the cover portion positioned on the side surface 1c includes a second cover portion. For example, when the cover portion positioned on the end surface 1b includes the first cover portion, the cover portion positioned on the side surface 1c includes the second cover portion.

The cover layer 20 includes, for example, glass. The glass included in the cover layer 20 includes, for example, SiO₂ or B₂O₃. When the cover layer 20 includes glass, the cover layer 20 is formed through applying glass slurry to the surfaces 1a, 1b, and 1c of the element body 1. The glass slurry includes, for example, glass powder, a binder resin, and a solvent. A thickness of the cover layer 20 is, for example, 1 to 3 μm. The glass included in the cover layer 20 includes, for example, amorphous glass.

The thickness of the cover layer 20 is obtained through, for example, the following process.

A cross-sectional photograph of the cover layer 20 is acquired. A cross-sectional photograph of the cover portion positioned on the end surface 1a is, for example, a photograph of a cross section of the cover layer 20 when the electronic component ED1 is cut along a plane orthogonal to the end surface 1a. A cross-sectional photograph of the cover portion positioned on the end surface 1b is, for example, a photograph of a cross section of the cover layer 20 when the electronic component ED1 is cut along a plane orthogonal to the end surface 1b. A cross-sectional photograph of the cover portion positioned on the side surface 1c1 is, for example, a photograph of a cross section of the cover layer 20 when the electronic component ED1 is cut along a plane orthogonal to the side surface 1c1. A cross-sectional photograph of the cover portion positioned on the side surface 1c2 is, for example, a photograph of a cross section of the cover layer 20 when the electronic component ED1 is cut along a plane orthogonal to the side surface 1c2. A cross-sectional photograph of the cover portion positioned on the side surface 1c3 is, for example, a photograph of a cross section of the cover layer 20 when the electronic component ED1 is cut along a plane orthogonal to the side surface 1c3. A cross-sectional photograph of the cover portion positioned on the side surface 1c4 is, for example, a photograph of a cross section of the cover layer 20 when the electronic component ED1 is cut along a plane orthogonal to the side surface 1c4.

The acquired cross-sectional photograph is subjected to image processing using software. From the image processing, a boundary of the cover layer 20 is determined, and the thickness of the cover portion on the acquired cross-sectional photograph is calculated. The thickness of the cover portion may be an average thickness of the cover portion on the acquired cross-sectional photograph.

The thickness of the cover layer 20 may be an average value of the thicknesses of all the cover portions.

In the present example, the conductor layer 30a is disposed on the cover layer 20 disposed on the end surface 1a. The conductor layer 30b is disposed on the cover layer 20 disposed on the end surface 1b. The conductor layers 30a and 30b are separated from each other in the first direction D1. The conductor layers 30a and 30b include regions opposing each other in the first direction D1 with the element body 1 interposed between the conductor layer 30a and the conductor layer 30b.

The conductor layer 30a is disposed, for example, on the cover layer 20 disposed on a part of the side surface 1c. In the configuration in which the conductor layer 30a is disposed on the cover layer 20 disposed on a part of the side surface 1c, the conductor layer 30a covers a ridge portion positioned between the end surface 1a and the side surface 1c and a corner portion positioned at both ends of the ridge portion. The conductor layer 30b is disposed, for example, on the cover layer 20 disposed on a part of the side surface 1c. In the configuration in which the conductor layer 30b is disposed on the cover layer 20 disposed on a part of the side surface 1c, the conductor layer 30b covers a ridge portion positioned between the end surface 1b and the side surface 1c and a corner portion positioned at both ends of the ridge portion.

The conductor layers 30a and 30b include, for example, a sintered metal layer. The sintered metal layer is formed through sintering the conductive paste applied to the surfaces 1a, 1b, and 1c of the element body 1. The sintered metal layer is formed, for example, through sintering a metal powder included in the conductive paste. The sintered metal layer includes a conductive material of a noble metal or a noble metal alloy. The noble metal includes, for example, Ag, Pd, Au, or Pt. The noble metal alloy includes, for example, an Ag—Pd alloy. The sintered metal layer may include a base metal or a base metal alloy. The base metal includes, for example, Cu or Ni. The conductive paste includes, for example, the above-described type of metal powder, a glass component, an organic binder, and an organic solvent. The conductive material included in the conductor layers 30a and 30b may be the same as the conductive material included in the coil conductors 10b to 10g and the through-hole conductors 11b to 11f. The coil conductors 10b to 10g, the through-hole conductors 11b to 11f, and the conductor layers 30a and 30b may include conductive materials different from each other. The thicknesses of the conductor layers 30a and 30b are, for example, 10 to 50 μm.

In the electronic component ED1, a plated layer PL is disposed on each of the conductor layers 30a and 30b. The plated layer PL is formed on each of the conductor layers 30a and 30b to cover each of the conductor layers 30a and 30b. In the present example, the conductor layers 30a and the plated layer PL constitute an external electrode, and the conductor layers 30b and the plated layer PL constitute an external electrode. The plated layer PL includes, for example, a two-layer structure. In the configuration in which the plated layer PL include a two-layer structure, a first layer includes, for example, a Ni plated layer, a Sn plated layer, a Cu plated layer, or an Au plated layer. A second layer formed on the first layer includes, for example, a Sn plated layer, a Sn—Ag alloy plated layer, a Sn—Bi alloy plated layer, or a Sn—Cu alloy plated layer. The plated layer PL may include a layered structure with three or more layers. The plated layer PL may not be formed on the conductor layers 30a and 30b.

Next, connection between the coil 10 and the conductor layers 30a and 30b will be described.

As illustrated in FIGS. 2 and 4, in the electronic component ED1, the end 12c is exposed at the end surface 1a. The conductor layer 30a includes a portion 30c. The portion 30c protrudes toward the element body 1 through the cover portion of the cover layer 20 that is positioned on the end surface 1a. The portion 30c protrudes through the cover layer 20. That is, the portion 30c penetrates through the cover layer 20. When the end 12c and the portion 30c are viewed in the first direction D1, the portion 30c covers the end 12c. In the present example, the portion 30c covers the entire end 12c. The end 12c is physically and electrically connected to the portion 30c. The portion 30c is physically connected to the coil conductor 10g. The portion 30c is physically and electrically connected to the coil conductor 10g. The portion 30c may cover a part of the end 12c. In this case, the part of the end 12c is physically connected to the portion 30c. In the present example, the conductor layer 30a includes a portion positioned on the cover layer 20. For example, when the portion positioned on the cover layer 20 includes a first portion, the portion 30c includes a second portion. In FIG. 4, the first direction D1 coincides with, for example, a direction orthogonal to the end surface 1a, and hatching is omitted to clearly illustrate each element.

As illustrated in FIGS. 2 and 5, in the electronic component ED1, the end 12d is exposed at the end surface 1b. The conductor layer 30b includes a portion 30d. The portion 30d protrudes toward the element body 1 through the cover portion of the cover layer 20 that is positioned on the end surface 1b. The portion 30d protrudes through the cover layer 20. That is, the portion 30d penetrates through the cover layer 20. When the end 12d and the portion 30d are viewed in the first direction D1, the portion 30d covers the end 12d. In the present example, the portion 30d covers the entire end 12d. The end 12d is physically and electrically connected to the portion 30d. The portion 30d is physically connected to the coil conductor 10g. The portion 30d is physically and electrically connected to the coil conductor 10b. The portion 30d may cover a part of the end 12d. In this case, the part of the end 12d is physically connected to the portion 30d. In the present example, the conductor layer 30b includes a portion positioned on the cover layer 20. For example, when the portion positioned on the cover layer 20 includes a first portion, the portion 30d includes a second portion.

The coil 10 is electrically connected to the portion 30c and the portion 30d. In FIG. 5, the first direction D1 coincides with, for example, a direction orthogonal to the end surface 1b, and hatching is omitted to clearly illustrate each element.

In the present example, a plurality of openings 20c and 20d are formed in the cover layer 20. The opening 20c is formed in the cover portion of the cover layer 20 that is positioned on the end surface 1a. The opening 20d is formed in the cover portion of the cover layer 20 that is positioned on the end surface 1b. The openings 20c and 20d are formed through, for example, irradiating the cover layer 20 with a laser beam.

The portion 30c is positioned in the opening 20c. The portion 30c protrudes through the cover portion of the cover layer 20 that is positioned on the end surface 1a in the opening 20c. When the cover portion positioned on the end surface 1a is viewed in the first direction D1, the end 12c is positioned in the opening 20c. The end 12c is exposed at the cover portion positioned on the end surface 1a. Apart of the end 12c may be positioned in the opening 20c. Apart of the end 12c may be exposed at the cover portion positioned on the end surface 1a. A planar shape of the portion 30c corresponds to, for example, a shape of the opening 20c.

The portion 30d is positioned in the opening 20d. The portion 30d protrudes through the cover portion of the cover layer 20 that is positioned on the end surface 1b in the opening 20d. When the cover portion positioned on the end surface 1b is viewed in the first direction D1, the end 12d is positioned in the opening 20d. The end 12d is exposed at the cover portion positioned on the end surface 1b. A part of the end 12d may be positioned in the opening 20d. A part of the end 12d may be exposed at the cover portion positioned on the end surface 1b. A planar shape of the portion 30d corresponds to, for example, a shape of the opening 20d.

In the present example, the openings 20c and 20d extend in the third direction D3. For example, the openings 20c and 20d may extend in a direction orthogonal to the first direction D1 and the second direction D2 and intersecting the third direction D3.

A length of the opening 20c in the second direction D2 is, for example, equal to or larger than a length of the end 12c in the second direction D2. The length of the opening 20c in the second direction D2 is, for example, 100 to 600 μm. The length of the end 12c in the second direction D2 is, for example, 40 to 400 μm.

A length of the opening 20c in the third direction D3 is, for example, equal to or larger than a length of the end 12c in the third direction D3. The length of the opening 20c in the third direction D3 is, for example, 100 to 600 μm. The length of the end 12c in the third direction D3 is, for example, 40 to 400 μm.

A ratio of an area of the opening 20c to an exposed area of the end 12c is, for example, 100 to 500%. The opening 20c has, for example, a rectangular shape when viewed in the first direction D1.

The length of each of the opening 20c and the end 12c in the second direction D2 is obtained through, for example, the following process.

A cross-sectional photograph of the cover portion of the cover layer 20 that is positioned on the end surface 1a and the end 12c is acquired. The cross-sectional photograph is, for example, a photograph of a cross section of the cover portion positioned on the end 12c and the end surface 1a when the electronic component ED1 is cut at a position including the end 12c along a plane orthogonal to the side surfaces 1c1 and 1c2. The acquired cross-sectional photograph is subjected to image processing using software. A boundary between the end 12c and the cover layer 20 is determined based on a result of the image processing, and the lengths of the opening 20c and the end 12c in the second direction D2 on the acquired cross-sectional photograph are calculated.

The length of each of the opening 20c and the end 12c in the third direction D3 is obtained through, for example, the following process.

A cross-sectional photograph of the cover portion of the cover layer 20 that is positioned on the end surface 1a and the end 12c is acquired. The cross-sectional photograph is, for example, a photograph of a cross section of the cover portion positioned on the end 12c and the end surface 1a when the electronic component ED1 is cut at a position including the end 12c along a plane parallel to the side surfaces 1c1 and 1c2. The acquired cross-sectional photograph is subjected to image processing using software. From the image processing, a boundary between the end 12c and the cover layer 20 is determined, and the length of each of the opening 20c and the end 12c in the third direction D3 on the acquired cross-sectional photograph is calculated.

The exposed area of the end 12c is obtained by, for example, the product of the length of the end 12c in the second direction D2 and the length of the end 12c in the third direction D3. The area of the opening 20c is obtained by, for example, the product of the length of the opening 20c in the second direction D2 and the length of the opening 20c in the third direction D3.

A length of the opening 20d in the second direction D2 is, for example, equal to or larger than a length of the end 12d in the second direction D2. The length of the opening 20d in the second direction D2 is, for example, 100 to 600 μm. The length of the end 12d in the second direction D2 is, for example, 40 to 400 μm.

A length of the opening 20d in the third direction D3 is, for example, equal to or larger than a length of the end 12d in the third direction D3. The length of the opening 20d in the third direction D3 is, for example, 100 to 600 μm. The length of the end 12d in the third direction D3 is, for example, 40 to 400 μm.

A ratio of an area of the opening 20d to an exposed area of the end 12d is, for example, 100 to 500%. The opening 20d has, for example, a rectangular shape when viewed in the first direction D1.

The length of the opening 20d in the second direction D2 may be the same as or different from the length of the opening 20c in the second direction D2. The length of the opening 20d in the third direction D3 may be the same as or different from the length of the opening 20c in the third direction D3.

The length of each of the opening 20d and the end 12d in the second direction D2 is obtained through, for example, the following process.

A cross-sectional photograph of the cover portion of the cover layer 20 that is positioned on the end surface 1b and the end 12d is acquired. The cross-sectional photograph is, for example, a photograph of a cross section of the cover portion positioned on the end 12d and the end surface 1b when the electronic component ED1 is cut at a position including the end 12d along a plane orthogonal to the side surfaces 1c1 and 1c2. The acquired cross-sectional photograph is subjected to image processing using software. From the image processing, a boundary between the end 12d and the cover layer 20 is determined, and the length of each of the opening 20d and the end 12d in the second direction D2 on the acquired cross-sectional photograph is calculated.

The length of each of the opening 20d and the end 12d in the third direction D3 is obtained through, for example, the following process.

A cross-sectional photograph of the cover portion of the cover layer 20 that is positioned on the end surface 1b and the end 12d is acquired. The cross-sectional photograph is, for example, a photograph of a cross section of the cover portion positioned on the end 12d and the end surface 1b when the electronic component ED1 is cut at a position including the end 12d along a plane parallel to the side surfaces 1c1 and 1c2. The acquired cross-sectional photograph is subjected to image processing using software. From the image processing, a boundary between the end 12d and the cover layer 20 is determined, and the length of each of the opening 20d and the end 12d in the third direction D3 on the acquired cross-sectional photograph is calculated.

The exposed area of the end 12d is obtained by, for example, the product of the length of the end 12d in the second direction D2 and the length of the end 12d in the third direction D3. The area of the opening 20d is obtained by, for example, the product of the length of the opening 20d in the second direction D2 and the length of the opening 20d in the third direction D3.

An edge 20e of the cover layer 20 that defines the opening 20c is positioned on the end surface 1a when viewed in a direction orthogonal to the end surface 1a. Therefore, the entire edge 20e is positioned inside an outer edge of the end surface 1a when viewed in the direction orthogonal to the end surface 1a. The length of the opening 20c in the second direction D2 is, for example, smaller than a length of the end surface 1a in the second direction D2. The length of the opening 20c in the third direction D3 is, for example, smaller than a length of the end surface 1a in the third direction D3. A ratio of the area of the opening 20c to an area of the end surface 1a is, for example, 3 to 50%.

The end surface 1a includes a region E1a and a region E2a. The region E1a is exposed from the cover layer 20 through the opening 20c. The region E2a is covered with the cover layer 20. In the present example, the region E2a surrounds the region E1a when viewed in the direction orthogonal to the end surface 1a. The region E1a is recessed relative to the region E2a. The end surface 1a is recessed at a position corresponding to the opening 20c. The region E1a is formed through, for example, irradiating the cover layer 20 with a laser beam. In the configuration in which the opening 20c is formed to protrude through the cover layer 20, the region E1a can be irradiated with a laser beam. The region E1a has, for example, a rectangular shape when viewed in the first direction D1. For example, when the region E1a includes a first region, the region E2a includes a second region. For example, when the region E1a includes a second surface region, the region E2a includes a first surface region.

An edge 20f of the cover layer 20 that defines the opening 20d is positioned on the end surface 1b when viewed in a direction orthogonal to the end surface 1b. Therefore, the entire edge 20f is positioned inside an outer edge of the end surface 1b when viewed in the direction orthogonal to the end surface 1b. The length of the opening 20d in the second direction D2 is, for example, smaller than a length of the end surface 1b in the second direction D2. The length of the opening 20d in the third direction D3 is, for example, smaller than a length of the end surface 1b in the third direction D3. A ratio of the area of the opening 20d to an area of the end surface 1b is, for example, 3 to 50%.

The ratio of the area of the opening 20d to the area of the end surface 1b may be the same as or different from the ratio of the area of the opening 20c to the area of the end surface 1a.

The end surface 1b includes a region E1b and a region E2b. The region E1b is exposed from the cover layer 20 through the opening 20d. The region E2b is covered with the cover layer 20. In the present example, the region E2b surrounds the region E1b when viewed in the direction orthogonal to the end surface 1b. The region E1b is recessed relative to the region E2b. The end surface 1b is recessed at a position corresponding to the opening 20d. The region E1b is formed through, for example, irradiating the cover layer 20 with a laser beam. In the configuration in which the opening 20d is formed to protrude through the cover layer 20, the region E1b can be irradiated with a laser beam. The region E1b has, for example, a rectangular shape when viewed in the first direction D1. For example, when the region E1b includes a first region, the region E2b includes a second region. For example, when the region E1b includes a second surface region, the region E2b includes a first surface region.

As illustrated in FIG. 6, in the present example, surface roughness of the region E1a is larger than surface roughness of the region E2a. For example, irradiating the region E1a with a laser beam may bring the difference in surface roughness between the region E1a and the region E2a. The surface roughness of the region E1a becomes larger than the surface roughness of the region E2a through, for example, irradiating the region E1a with a laser beam. The region E2a is not irradiated with a laser beam. For example, the surface roughnesses of the regions E1a and E2a are defined by the maximum heights (Rz) of the regions E1a and E2a, respectively. The maximum height (Rz) is defined in JIS B 0601:2001 (ISO 4287:1997).

The surface roughness of each of the regions E1a and E2a is obtained through, for example, the following process.

A cross-sectional photograph of the regions E1a and E2a is acquired. The cross-sectional photograph is, for example, a photograph of a cross section of the end surface 1a when the electronic component ED1 is cut at a position including the regions E1a and E2a along a plane parallel to the side surfaces 1c1 and 1c2. The acquired cross-sectional photograph is subjected to image processing using software. From the image processing, a boundary of the end surface 1a is determined, and the surface roughness of each of the regions E1a and E2a on the acquired cross-sectional photograph is calculated. In FIG. 6, hatching is omitted to clearly illustrate each element.

Although not illustrated, in the present example, the surface roughness of the region E1b is larger than the surface roughness of the region E2b. For example, irradiating the region E1b with a laser beam may bring the difference in surface roughness between the region E1b and the region E2b. The surface roughness of the region E1b becomes larger than the surface roughness of the region E2b through, for example, irradiating the region E1b with a laser beam. The region E2b is not irradiated with a laser beam.

The surface roughness of each of the regions E1b and E2b is obtained through, for example, the following process.

A cross-sectional photograph of the regions E1b and E2b is acquired. The cross-sectional photograph is, for example, a photograph of a cross section of the end surface 1b when the electronic component ED1 is cut at a position including the regions E1b and E2b along a plane parallel to the side surfaces 1c1 and 1c2. The acquired cross-sectional photograph is subjected to image processing using software. From the image processing, a boundary of the end surface 1b is determined, and the surface roughness of each of the regions E1b and E2b on the acquired cross-sectional photograph is calculated.

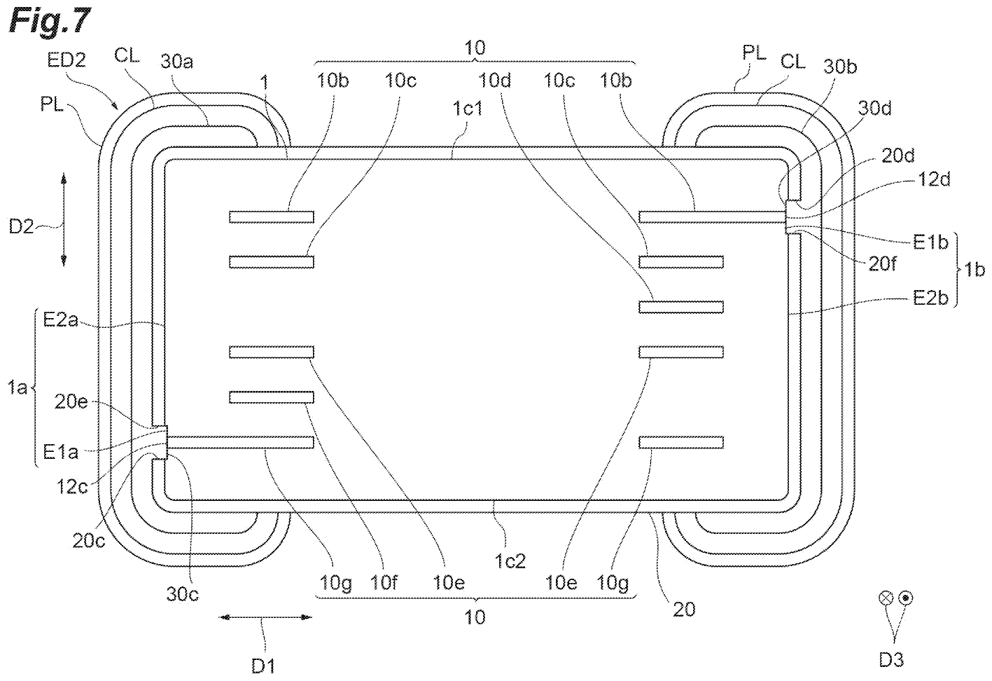

A configuration of an electronic component ED2 according to a modification of the present example will be described with reference to FIG. 7. FIG. 7 is a view illustrating a cross-sectional configuration of an electronic component according to a modification of the present example. The electronic component ED2 includes the same configuration as the electronic component ED1 described above except that the electronic component ED2 includes a conductive resin layer CL.

The electronic component ED2 includes a plurality of conductive resin layers CL. In the present modification, the electronic component ED2 includes a pair of conductive resin layers CL. Each of the pair of conductive resin layers CL is disposed in the corresponding conductor layer 30a or 30b of the conductor layers 30a and 30b. The conductive resin layer CL covers the entire corresponding conductor layer 30a or 30b. The conductive resin layer CL is in contact with the cover layer 20 at an end portion thereof. The conductive resin layer CL is in contact with the corresponding conductor layer 30a or 30b. The conductive resin layer CL is positioned between the corresponding conductor layer 30a or 30b and the plated layer PL. The conductive resin layer CL is in contact with the plated layer PL. The conductive resin layer CL is formed on the corresponding conductor layer 30a or 30b. The conductor layers 30a and 30b include substrate metal layers. In FIG. 7, hatching is omitted to clearly illustrate each element.

The conductive resin layer CL may cover only a part of the corresponding conductor layer 30a or 30b. In the configuration in which the conductive resin layer CL covers only a part of the corresponding conductor layer 30a or 30b, the plated layer PL is disposed on the conductive resin layer CL and on a region exposed at the conductive resin layer CL in each of the conductor layers 30a and 30b. In this configuration, the plated layer PL is in contact with the conductor layer 30a or 30b.

The conductive resin layer CL includes a resin and a plurality of conductive particles. The resin includes, for example, a thermosetting resin. The thermosetting resin includes, for example, a phenol resin, an acrylic resin, a silicone resin, an epoxy resin, or a polyimide resin. The conductive particles include, for example, metal particles or metal-plated particles. The metal particles include, for example, silver particles or copper particles.

The conductive resin layer CL is formed through, for example, curing a conductive resin paste applied to the corresponding conductor layer 30a or 30b. The conductive resin paste includes, for example, a resin, a plurality of conductive particles, and an organic solvent.

As described above, the electronic components ED1 and ED2 each include the element body 1, the plurality of coil conductors 10b to 10g, the cover layer 20, and the conductor layers 30a and 30b. The plurality of coil conductors 10b to 10g are disposed in the element body 1. The cover layer 20 is disposed on the outer surface of the element body 1 and has an electrical insulation property. The conductor layers 30a and 30b are disposed on the cover layer 20 and are electrically connected to the plurality of coil conductors 10b to 10g. The conductor layer 30a includes a portion 30c. The portion 30c protrudes toward the element body 1 through the cover layer 20, and is physically and electrically connected to the coil conductor 10g. The conductor layer 30b includes a portion 30d. The portion 30d protrudes toward the element body 1 through the cover layer 20, and is physically and electrically connected to the coil conductor 10b.

In the electronic components ED1 and ED2, the conductor layer 30a includes the portion 30c, and the conductor layer 30b includes the portion 30d. Therefore, the electronic components ED1 and ED2 prevent a decrease in physical and electrical connectivity between the coil conductor 10g as the internal conductor and the conductor layer 30a, and prevent a decrease in physical and electrical connectivity between the conductor layer 30b and the coil conductor 10b as the internal conductor.

In the electronic components ED1 and ED2, the coil conductor 10g includes the end 12c exposed at the end surface 1a. The portion 30c covers the end 12c when the end 12c and the portion 30c are viewed in the first direction D1. Therefore, the electronic components ED1 and ED2 reliably physically and electrically connect the coil conductor 10g and the conductor layer 30a.

The coil conductor 10b includes the end 12d exposed at the end surface 1b. The portion 30d covers the end 12d when the end 12d and the portion 30d are viewed in the first direction D1. Therefore, the electronic components ED1 and ED2 reliably physically and electrically connect the coil conductor 10b and the conductor layer 30b.

In the electronic components ED1 and ED2, the opening 20c is formed in the cover layer 20 at a position corresponding to the portion 30c. The edge 20e included in the cover layer 20 and defining the opening 20c is positioned on the end surface 1a when viewed in the first direction D1. Therefore, the electronic components ED1 and ED2 reliably position the portion 30c on the end surface 1a. As a result, the electronic components ED1 and ED2 reliably prevent a decrease in physical and electrical connectivity between the coil conductor 10g and the conductor layer 30a.

In the cover layer 20, the opening 20d is formed in the cover layer at a position corresponding to the portion 30d. The edge 20f included in the cover layer 20 and defining the opening 20d is positioned on the end surface 1b when viewed in the first direction D1. Therefore, the electronic components ED1 and ED2 reliably position the portion 30d on the end surface 1b. As a result, the electronic components ED1 and ED2 reliably prevent a decrease in physical and electrical connectivity between the coil conductor 10b and the conductor layer 30b.

In the electronic components ED1 and ED2, the end surface 1a includes the region E2a and the region E1a recessed relative to the region E2a. The electronic components ED1 and ED2 increase a connection area between the element body 1 and the conductor layer 30a. Therefore, the electronic components ED1 and ED2 strengthen physical connectivity between the conductor layer 30a and the element body 1. As a result, the electronic components ED1 and ED2 more reliably prevent a decrease in physical and electrical connectivity between the coil conductor 10g and the conductor layer 30a.

The end surface 1b includes the region E2b and the region E1b recessed relative to the region E2b. The electronic components ED1 and ED2 increase a connection area between the element body 1 and the conductor layer 30b. Therefore, the electronic components ED1 and ED2 strengthen physical connectivity between the conductor layer 30b and the element body 1. As a result, the electronic components ED1 and ED2 more reliably prevent a decrease in physical and electrical connectivity between the coil conductor 10b and the conductor layer 30b.

In the electronic components ED1 and ED2, the surface roughness of the region E1a is larger than the surface roughness of the region E2a. The electronic components ED1 and ED2 increase the surface area of the element body in the region E1a and increase the connection area between the element body 1 and the conductor layer 30a. Therefore, the electronic components ED1 and ED2 strengthen physical connectivity between the conductor layer 30a and the element body 1. As a result, the electronic components ED1 and ED2 more reliably prevent a decrease in physical and electrical connectivity between the coil conductor 10g and the conductor layer 30a.

The surface roughness of the region E1b is larger than the surface roughness of the region E2b. The electronic components ED1 and ED2 increase a surface area of the element body in the region E1b and increase the connection area between the element body 1 and the conductor layer 30b. Therefore, the electronic components ED1 and ED2 strengthen physical connectivity between the conductor layer 30b and the element body 1. As a result, the electronic components ED1 and ED2 more reliably prevent a decrease in physical and electrical connectivity between the coil conductor 10b and the conductor layer 30b.

The end 12c may be covered with the cover layer 20 even when exposed at the end surface 1a. In the configuration in which the end 12c is covered with the cover layer 20, the end 12c tends not to be physically or electrically connected to the conductor layer 30a. However, in the configuration in which the opening 20c is formed in the cover layer 20, the end 12c is easily physically and electrically connected to the conductor layer 30a protruding through the cover layer 20. The opening 20c is formed through, for example, irradiating the cover layer 20 with a laser beam. Even in a configuration in which the end 12c is not exposed at the end surface 1a, for example, when the end surface 1a is scraped, the end 12c can be exposed at the end surface 1a. The end 12c exposed at the end surface 1a is easily physically and electrically connected to the conductor layer 30a protruding through the cover layer 20. The end surface 1a is scraped through, for example, irradiation of the end surface 1a with a laser beam after the opening 20c is formed through irradiation of the cover layer 20 with a laser beam.

The end 12d may be covered with the cover layer 20 even when exposed at the end surface 1b. In the configuration in which the end 12d is covered with the cover layer 20, the end 12d tends not to be physically or electrically connected to the conductor layer 30b. However, in the configuration in which the opening 20d is formed in the cover layer 20, the end 12d is easily physically and electrically connected to the conductor layer 30b protruding through the cover layer 20. The opening 20d is formed through, for example, irradiating the cover layer 20 with a laser beam. Even in a configuration in which the end 12d is not exposed at the end surface 1b, for example, when the end surface 1b is scraped, the end 12d can be exposed at the end surface 1b. The end 12d exposed at the end surface 1b is easily physically and electrically connected to the conductor layer 30b protruding through the cover layer 20. The end surface 1b is scraped through, for example, irradiation of the end surface 1b with a laser beam after the opening 20d is formed through irradiation of the cover layer 20 with a laser beam.

In the electronic components ED1 and ED2, the cover layer 20 is continuously disposed on the end surface 1a and the side surface 1c. Therefore, the electronic components ED1 and ED2 reliably improve mechanical strength of the element body 1.

The cover layer 20 is continuously disposed on the end surface 1b and the side surface 1c. Therefore, the electronic components ED1 and ED2 reliably improve mechanical strength of the element body 1.

In the electronic components ED1 and ED2, the cover layer 20 has a thickness of 1 to 3 μm. Therefore, the electronic components ED1 and ED2 further improve mechanical strength of the element body 1.

Although the example and modification of the present disclosure have been described above, the present disclosure is not necessarily limited to the above-described example and modification, and various modifications can be made without departing from the gist thereof. The region E1a may not be recessed relative to the region E2a.

The configuration in which the region E1a is recessed relative to the region E2a more reliably prevents a decrease in physical and electrical connectivity between the coil conductor 10g and the conductor layer 30a as described above.

The region E1b may not be recessed relative to the region E2b. The configuration in which the region E1b is recessed relative to the region E2b more reliably prevents a decrease in physical and electrical connectivity between the coil conductor 10b and the conductor layer 30b as described above.

The surface roughness of the region E1a may not be larger than the surface roughness of the region E2a. The configuration in which the surface roughness of the region E1a is larger than the surface roughness of the region E2a more reliably prevents a decrease in physical and electrical connectivity between the coil conductor 10g and the conductor layer 30a as described above.

The surface roughness of the region E1b may not be larger than the surface roughness of the region E2b. The configuration in which the surface roughness of the region E1b is larger than the surface roughness of the region E2b more reliably prevents a decrease in physical and electrical connectivity between the coil conductor 10b and the conductor layer 30b as described above.

The cover layer 20 may not be disposed continuously on the end surfaces 1a and 1b and the side surface 1c. The configuration in which the cover layer 20 is continuously disposed on the end surfaces 1a and 1b and the side surface 1c improves mechanical strength of the element body 1 as described above. In a configuration in which the cover layer 20 is not disposed continuously on the end surfaces 1a and 1b and the side surface 1c, the conductive resin layer CL may be in contact with the element body 1 at the end portion thereof.

In the present example and the modification, the multilayer coil component has been described as an example of the electronic components ED1 and ED2, but the applicable electronic component is not limited to the multilayer coil component. Examples of the applicable electronic component include a multilayer electronic component such as a multilayer capacitor component, a multilayer inductor component, a multilayer varistor component, a multilayer solid battery component, a multilayer thermistor component, or a multilayer composite component, or an electronic component other than the multilayer electronic component.

What is claimed is:

1. An electronic component comprising:
an element body;
an internal conductor disposed in the element body;
a cover layer disposed on an outer surface of the element body and having an electrical insulation property; and
a conductor layer disposed on the cover layer and electrically connected to the internal conductor,
wherein the conductor layer includes a portion protruding toward the element body through the cover layer and physically and electrically connected to the internal conductor.

2. The electronic component according to claim 1, wherein
the outer surface includes an end surface at which the internal conductor is exposed, and
the cover layer is disposed on the end surface.

3. The electronic component according to claim 2, wherein
the internal conductor includes an end exposed at the end surface, and
the portion of the conductor layer covers the end of the internal conductor when the end and the portion are viewed in a direction orthogonal to the end surface.

4. The electronic component according to claim 2, wherein
an opening is formed in the cover layer at a position corresponding to the portion of the conductor layer, and
an edge included in the cover layer and defining the opening is positioned on the end surface when viewed in a direction orthogonal to the end surface.

5. The electronic component according to claim 2, wherein
an opening is formed in the cover layer at a position corresponding to the portion of the conductor layer,
the end surface includes a first region exposed from the cover layer through the opening, and a second region covered with the cover layer, and
the first region is recessed relative to the second region.

6. The electronic component according to claim 2, wherein
an opening is formed in the cover layer at a position corresponding to the portion of the conductor layer,
the end surface includes a first region exposed from the cover layer through the opening, and a second region covered with the cover layer, and
surface roughness of the first region is larger than surface roughness of the second region.

7. The electronic component according to claim 2, wherein
the outer surface further includes a side surface adjacent to the end surface, and
the cover layer is disposed continuously on the end surface and the side surface.

8. The electronic component according to claim 1, wherein
the cover layer has a thickness of 1 to 3 μm.

9. An electronic component comprising:
an element body;
an internal conductor disposed in the element body;
a cover layer disposed on the element body and having an electrical insulation property; and
a conductor layer electrically connected to the internal conductor and including a first portion on the cover layer and a second portion penetrating through the cover layer and physically connected to the internal conductor.

10. The electronic component according to claim 9, wherein
the element body includes an end surface at which the internal conductor is exposed, and
the cover layer includes a cover portion on the end surface.

11. The electronic component according to claim 10, wherein
the internal conductor includes an end exposed at the end surface, and
the second portion of the conductor layer covers the end of the internal conductor when the end and the second portion are viewed in a direction orthogonal to the end surface.

12. The electronic component according to claim 10, wherein
the cover portion is formed with an opening at a position corresponding to the second portion, and includes an edge defining the opening and positioned on the end surface when viewed in a direction orthogonal to the end surface.

13. The electronic component according to claim 10, wherein
the cover layer is formed with an opening at a position corresponding to the second portion of the conductor layer, and
the end surface includes a first surface region covered with the cover layer, and a second surface region exposed from the cover layer through the opening and recessed relative to the first surface region.

14. The electronic component according to claim 10, wherein
the cover layer is formed with an opening at a position corresponding to the second portion of the conductor layer, and
the end surface includes a first surface region covered with the cover layer, and a second surface region exposed from the cover layer through the opening and having surface roughness larger than surface roughness of the first surface region.

15. The electronic component according to claim 10, wherein
the element body further includes a side surface adjacent to the end surface, and
the cover layer includes a first cover portion on the end surface and a second cover portion on the side surface, the first cover portion and the second cover portion being continuous with each other.
